(19) United States
(12) Patent Application Publication
(10) Pub. No.: US 2014/0201268 A1
(43) Pub. Date: Jul. 17, 2014

(54) DATA PLACEMENT SYSTEM, DISTRIBUTED ACCESS NODE, DATA PLACEMENT METHOD AND PROGRAM

(71) Applicant: Norihisa Iga, Tokyo (JP)

(72) Inventor: Norihisa Iga, Tokyo (JP)

(73) Assignee: NEC CORPORATION, Tokyo (JP)

(21) Appl. No.: 14/343,037

(22) PCT Filed: Sep. 5, 2012
(86) PCT No.: PCT/JP2012/072559

§ 371 Date: Mar. 5, 2014

(30) Foreign Application Priority Data
Sep. 6, 2011 (JP) 2011-193634

(51) Int. Cl. H04L 29/08

(52) U.S. Cl. CPC H04L 67/1021; H04L 67/1097
USPC 709/203

(57) ABSTRACT

Realized is load distribution among a plurality of nodes that store data updated over a wide range with high frequency. A data placement system includes a plurality of nodes that store data transmitted by client nodes and a distributed access node arranged between the plurality of nodes and the client nodes. The distributed access node comprises a node area information holding unit that holds node area information associating each of the nodes with at least one piece of area information, an area specifying unit that specifies an area where the client node is located, and a node specifying unit that selects a node associated with the specified area as the storage location of data transmitted from the client node.

### REFERENCE TO RELATED APPLICATION

The present invention is based upon and claims the benefit of the priority of Japanese patent application No. 2011-193634 filed on Sep. 6, 2011, the disclosure of which is incorporated herein in its entirety by reference thereto.

### TECHNICAL FIELD

The present invention relates to a data placement system, distributed access node, data placement method and program, and particularly to a data placement system, distributed access node, data placement method and program that store data transmitted from a client in a plurality of nodes.

### BACKGROUND

Patent Literature 1 discloses a management program capable of leveling the loads of storage nodes belonging to a distribution storage system. The document states, “a computer executing this management program functions as load information obtaining means, assignment means, and instruction means. The load information obtaining means obtains information of accesses to each actual storage area included in each storage node from a plurality of storage nodes, generates load information of each actual storage area based on the obtained access information, and stores the generated load information in the load information storage means. The assignment means changes the assignment relations of the actual storage areas with respect to virtual storage areas such that the load of each storage nodes are leveled based on the load information stored in the load information storage means. The instruction means instructs the plurality of storage nodes to move data in the actual storage areas depending on change in the assignment of the actual storage areas to the virtual storage areas.”

### CITATION LIST

### Patent Literature

### Patent Literature 1

Japanese Patent Kokai Publication No. JP-P2010-277289A

### SUMMARY

### Technical Problem

The following analysis is given by the present invention. A data center is often used as a place that stores data transmitted regularly and frequently from devices always accompanied by a position such as mobile telephones and vehicles (such a device is referred to as “client node” hereinafter). These client nodes constantly move, and they are sometimes turned off and become unavailable to be managed. Further, based on the content of data notified by a first client node to the data center, a second client node nearby is identified, and a request is made to send a notification to the second client node. In order to manage the data of client nodes with such characteristics, the data center has to arrange the data efficiently.

In this regard, the method disclosed in Patent Literature 1 arranges data based on the access information such as the frequency of accesses to the data so that loads are leveled. However, there is a problem that load distribution based on the access frequency is not effective in a system in which all data are updated almost on a regular basis, such as the data center that stores data transmitted by the client nodes, since all the data are accessed almost evenly and frequently.

Further, the method disclosed in Patent Literature 1 has another problem that obtaining the access information from each node to grasp the load status creates a network load other than data access to each node.

It is an object of the present invention to provide a data placement system, distributed access node, data placement method and program capable of contributing to load distribution among nodes that store data updated over a wide range with high frequency, such as the data transmitted by the aforementioned client node.

### Solution to Problem

According to a first aspect of the present invention, there is provided a data placement system including a plurality of nodes that store data transmitted by a client node at a predetermined frequency, and a distributed access node arranged between the plurality of nodes and the client node; and the distributed access node comprises a node area information holding unit that holds node area information associating each of the nodes with at least one piece of area information, an area specifying unit that specifies an area where the client node is located, and a node specifying unit that selects a node associated with the specified area as a storage location of data transmitted by the client node.

According to a second aspect of the present invention, there is provided a distributed access node arranged between a plurality of nodes that store data transmitted by a client node and the client node; and the distributed access node comprises a node area information holding unit that holds node area information associating each of the nodes with at least one piece of area information, an area specifying unit that specifies an area where the client node is located, and a node specifying unit that selects a node associated with the specified area as a storage location of data transmitted by the client node.

According to a third aspect of the present invention, there is provided a data placement method for selecting a storage location of data transmitted by a client node from a plurality of nodes, and the data placement method includes a step of having a distributed access node arranged between the plurality of nodes and the client node specify an area where the client node is located, and a step of having the distributed access node select a node associated with the specified area as a storage location of data transmitted by the client node by referring to node area information associating each of the nodes with at least one piece of area information. The present method is tied to a particular machine, which is a distributed access node arranged between a plurality of nodes and a client node to select a storage location of data.

According to a fourth aspect of the present invention, there is provided a program that has a computer constituting a distributed access node arranged between a plurality of nodes that store data transmitted by a client node and the client node execute a process of specifying an area where the client node is located, and a process of selecting a node associated with the specified area as a storage location of data transmitted by the client node by referring to node area information associating each of the nodes with at least one piece of area information. Further, this program can be stored in a computer-readable storage medium. In other words, the present invention can be realized as a computer program product.

### Advantageous Effects of Invention

According to the present invention, it becomes possible to perform load distribution among nodes that store data updated over a wide range with high frequency.

### BRIEF DESCRIPTION OF DRAWINGS

FIG. 1 is a block diagram illustrating an entire configuration of a first exemplary embodiment of the present invention.

FIG. 2 is a block diagram illustrating the configuration of a distributed access node of the first exemplary embodiment of the present invention.

FIG. 3 is an example of area information held by the distributed access node of the first exemplary embodiment of the present invention.

FIG. 4 is an example of node area information held by the distributed access node of the first exemplary embodiment of the present invention.

FIG. 5 is an example of a table for managing client management information.

FIG. 6 is a drawing showing client nodes plotted in areas corresponding to the node area information in FIG. 3.

FIG. 7 is a flowchart showing the operation of the distributed access node of the first exemplary embodiment of the present invention.

FIG. 8 is a drawing for explaining the processing of updating the node area information.

FIG. 9 is a drawing for explaining updated node area information after step A5 in FIG. 7.

FIG. 10 is a drawing showing another configuration example of threshold information.

FIG. 11 is a block diagram illustrating the configuration of a distributed access node of a second exemplary embodiment of the present invention.

FIG. 12 is another example of the table for managing the client management information.

FIG. 13 is a flowchart showing the operation of the distributed access node of the second exemplary embodiment of the present invention.

FIG. 14 is a block diagram illustrating the configuration of a distributed access node of a third exemplary embodiment of the present invention.

FIG. 15 is an example of the node area information held by the distributed access node of the third exemplary embodiment of the present invention.

FIG. 16 is a flowchart showing the operation of the distributed access node of the third exemplary embodiment of the present invention.

### MODES

First, a summary of an exemplary embodiment of the present invention will be given with reference to the drawings. Note that drawing reference signs in the summary are given to each element for convenience as examples solely for facilitating understanding and the present invention is not limited to the exemplary embodiments shown in the drawings.

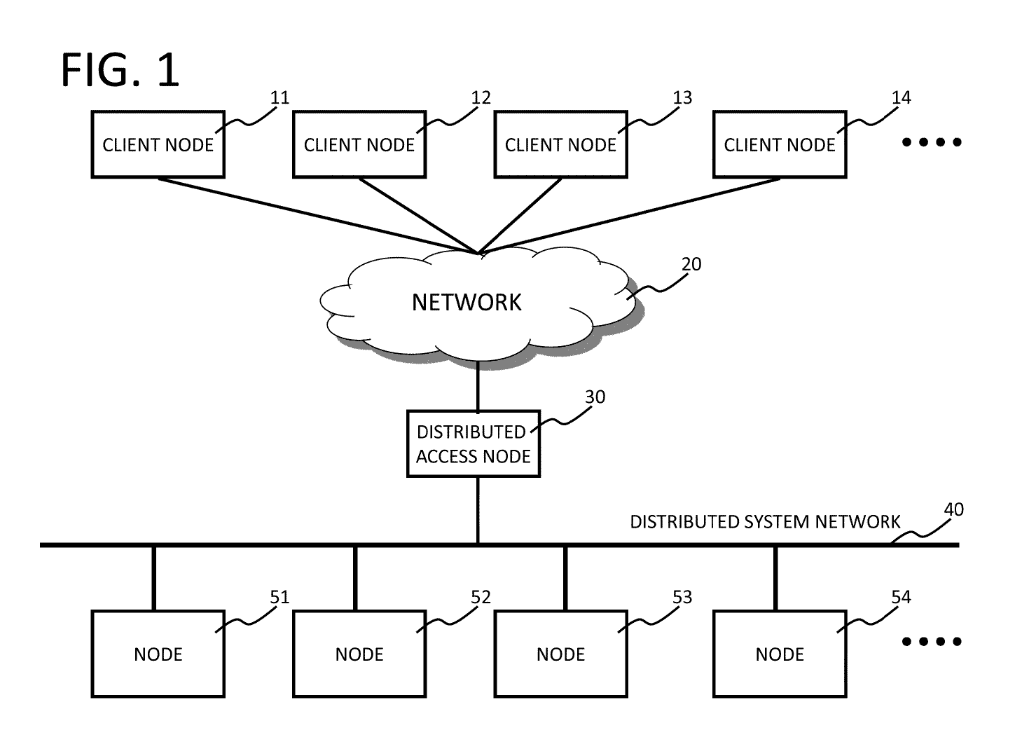

The present invention in an exemplary embodiment thereof can be realized with a plurality of nodes that store data transmitted by client nodes and a distributed access node disposed between the plurality of nodes and the client nodes, as shown in FIG. 1. More concretely, the distributed access node comprises an area specifying unit that specifies an area where a client node is located, and a node specifying unit that selects a node associated with the specified area as the storage location of the data transmitted from the client node by referring to node area information associating at least one piece of area information with each node.

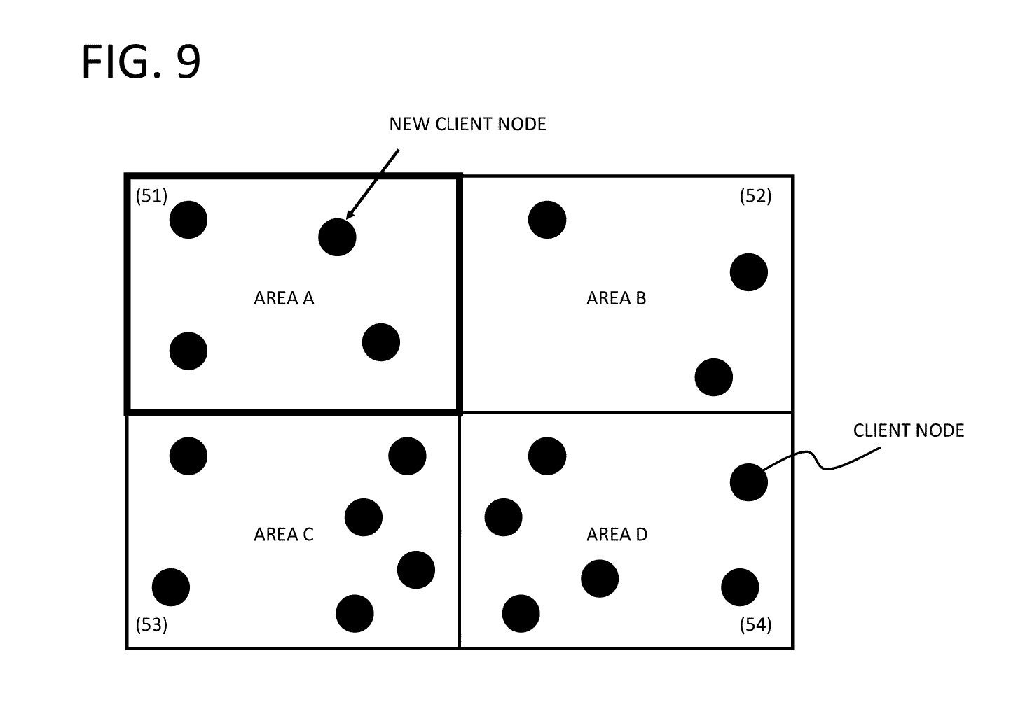

For instance, when areas A to D shown in FIG. 9 are associated with nodes 51 to 54, respectively, the distributed access node selects a node associated with an area where a client node is located from the nodes 51 to 54 as the storage location.

According to the configuration above, it becomes possible to perform load distribution among the nodes that store data updated over a wide range with high frequency.

### Exemplary Embodiment 1

Next, a first exemplary embodiment of the present invention will be described in detail with reference to the drawings. FIG. 1 is a block illustrating an entire configuration of the first exemplary embodiment of the present invention. With reference to FIG. 1, shown is a configuration that includes client nodes 11 to 14, a network 20, a distributed access node 30, a distributed system network 40, and the nodes 51 to 54 constituted by servers, storages, etc. Note that four client nodes and four nodes are shown in the example in FIG. 1, however, these numbers are selected to facilitate understanding of the present invention, and client nodes and nodes equal to or more than this can be used.

The client nodes 11 to 14 using the distributed system are connected to the distributed access node 30 via the network 20. The client nodes 11 to 14 transmit data obtained from a sensor provided for each sensor to the distributed access node 30. The client nodes 11 to 14 transmit information that enables identifying the area where each client node is located, having the information included in the data or having the information attached to the data.

Based on the information included in or attached to the data transmitted by the client nodes 11 to 14, the distributed access node 30 uniquely determines the storage location of the data using a distributed positioning algorithm described later, and outputs a request to write or update the data received from the client nodes 11 to 14 to the nodes 51 to 54, the storage location of the data, via the distributed system network 40.

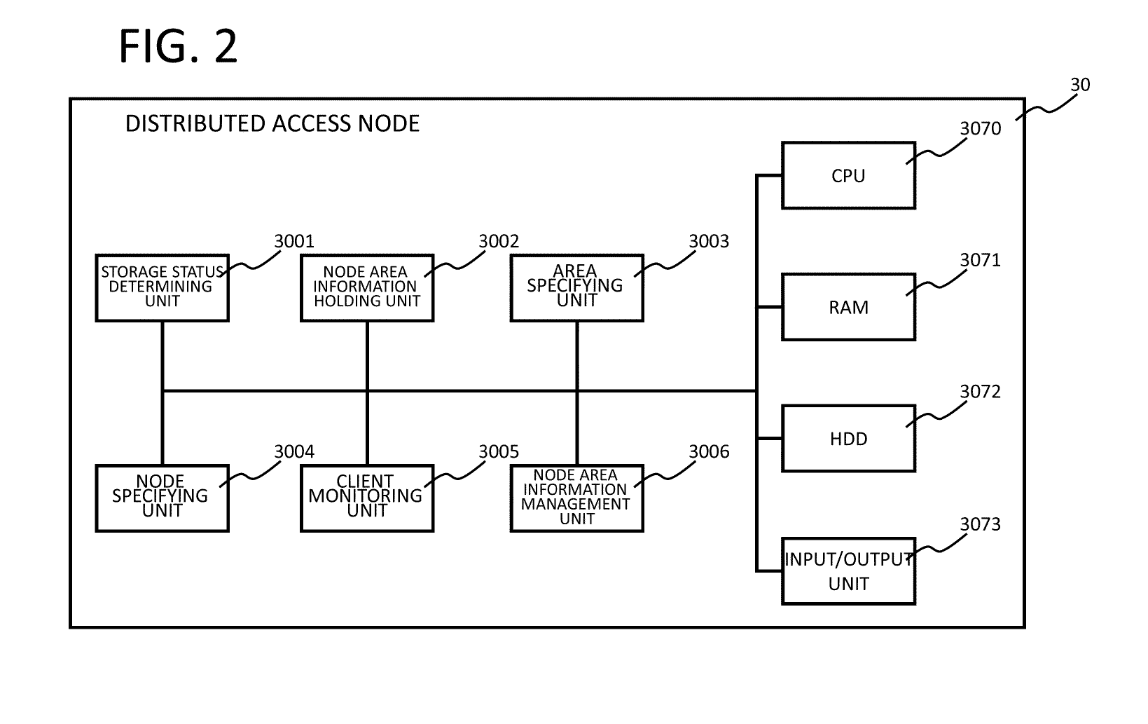

FIG. 2 is a block diagram illustrating the configuration of the distributed access node 30 of the first exemplary embodiment shown in FIG. 1. With reference to FIG. 2, shown is a configuration of the distributed access node 30 that comprises a storage status determining unit 3001, a node area information holding unit 3002, an area specifying unit 3003, a node specifying unit 3004, a client monitoring unit 3005, a node area information management unit 3006, a CPU (Central Processing Unit) 3070, RAM (Random Access Memory) 3071, an HDD (Hard Disk Drive) 3072, and an input/output unit 3073.

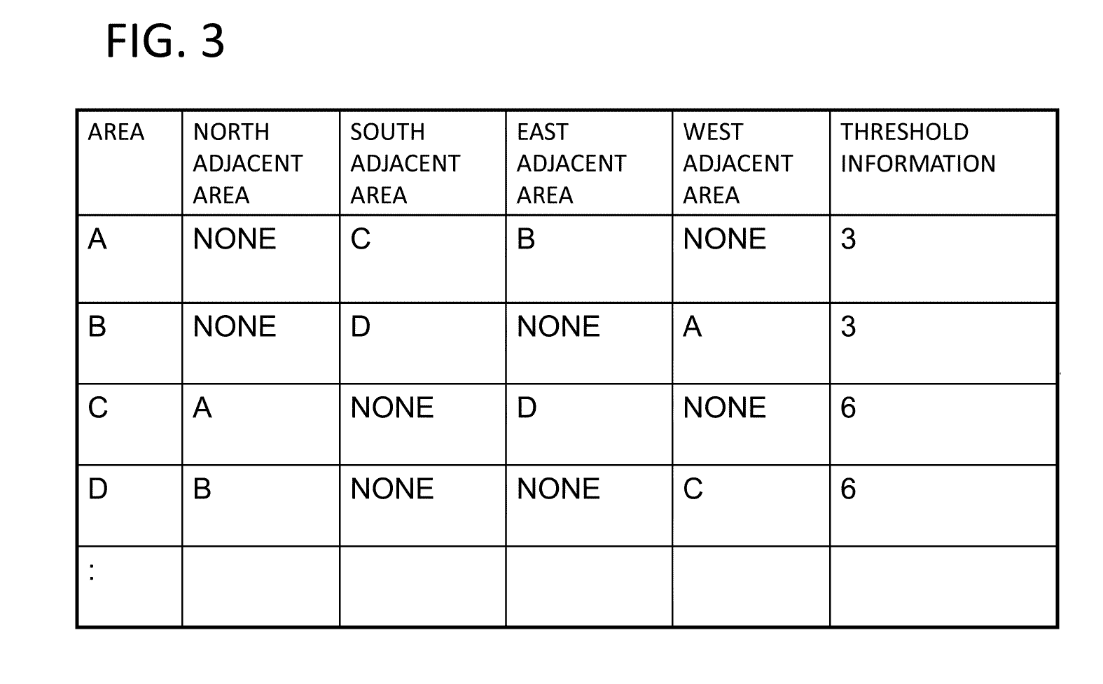

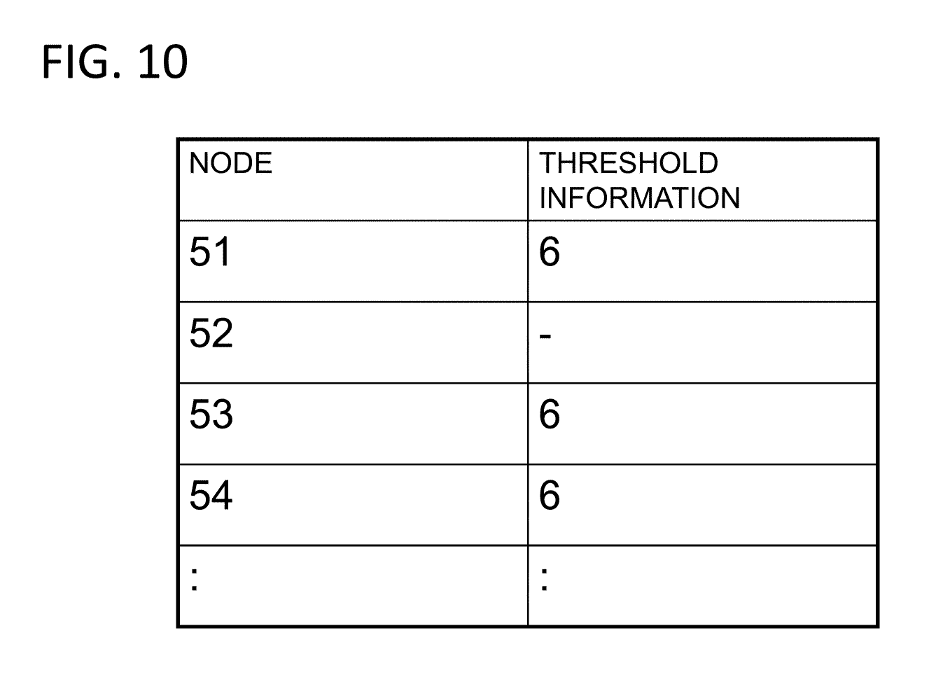

The storage status determining unit 3001 determines whether or not the range of predetermined threshold information will be exceeded if data transmitted from a new client node is stored in a node specified by the node specifying unit 3004 out of the nodes 51 to 54. The present exemplary embodiment will be explained with an assumption that the number of the client nodes manageable by the nodes 51 to 54, i.e., an upper limit number of data transmitted by the client nodes, has been set as the threshold information. Further, in the description below, a piece of data transmitted by a client node is counted as one, and the number of the client nodes is treated as the number of transmitted data. Further, the threshold information may be set for each area as shown in FIG. 3, or it may be set and managed for each node as shown in FIG. 10.

The node area information holding unit 3002 holds information of an area obtained by dividing a region into a particular size with location information of the area. Hereinafter, this area is referred to as “area,” and the information on the area is called “area information.” As an example of the area unit, an area can be divided into a size with a length of several km and a width of several km. Further, as another example, when a mobile telephone network is utilized as a communication network, an area covered by a base station in the mobile telephone network can be one area. Further, the node area information holding unit 3002 holds information associating the configuration of each area with information on the number of client nodes that can be stored in each area. This information is referred to as “area configuration information.” Further, the node area information holding unit 3002 holds information that associates each of the nodes 51 to 54 with at least one piece of the area information. This information is called “node area information.”

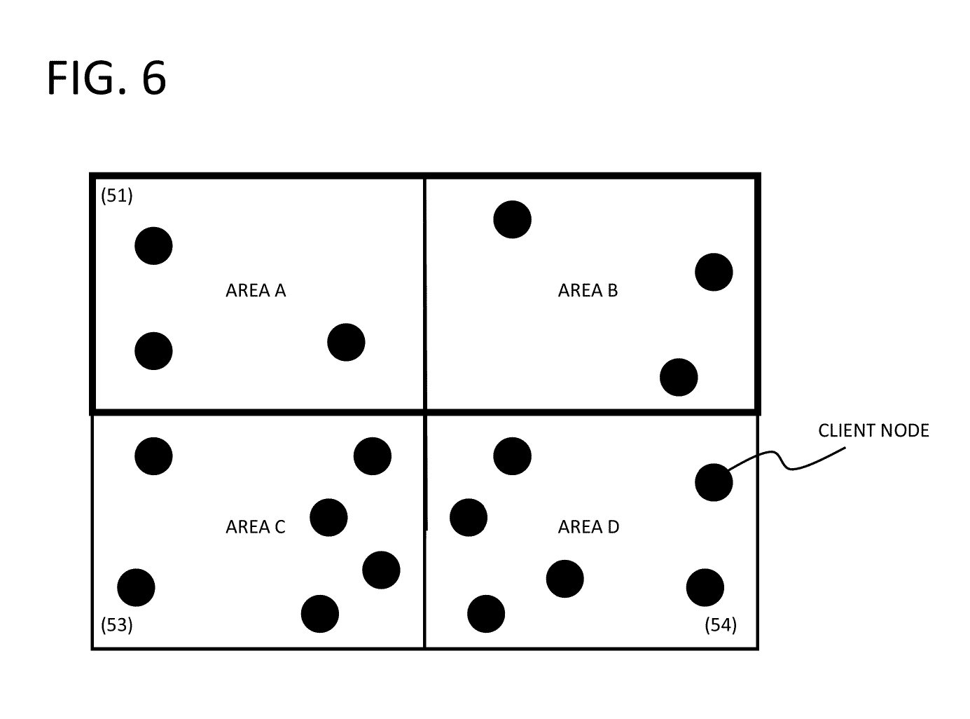

FIG. 3 shows an example of the area configuration information that includes the configuration of areas A to D shown in FIG. 6 and the threshold information thereof. Further, the values in the threshold information fields in FIG. 3 show the number of client nodes that can be stored in each of the areas. In the example of FIG. 3, the threshold information of the areas A and B is three. This indicates that the upper limit number of transmitted data that can be stored in the areas A and B is three. The threshold information is determined based on the processing capability of the node associated with an area in question. For instance, if the memory area such as RAM and the processing capability such as the CPU speed of each node is known, an optimal threshold value can be set for each node based on these pieces of information. Further, the threshold information may be set in advance based on information obtained at the time of system construction. When a new node is added to the nodes 51 to 54, the new node may notify its processing capability so that threshold information can be set based thereon.

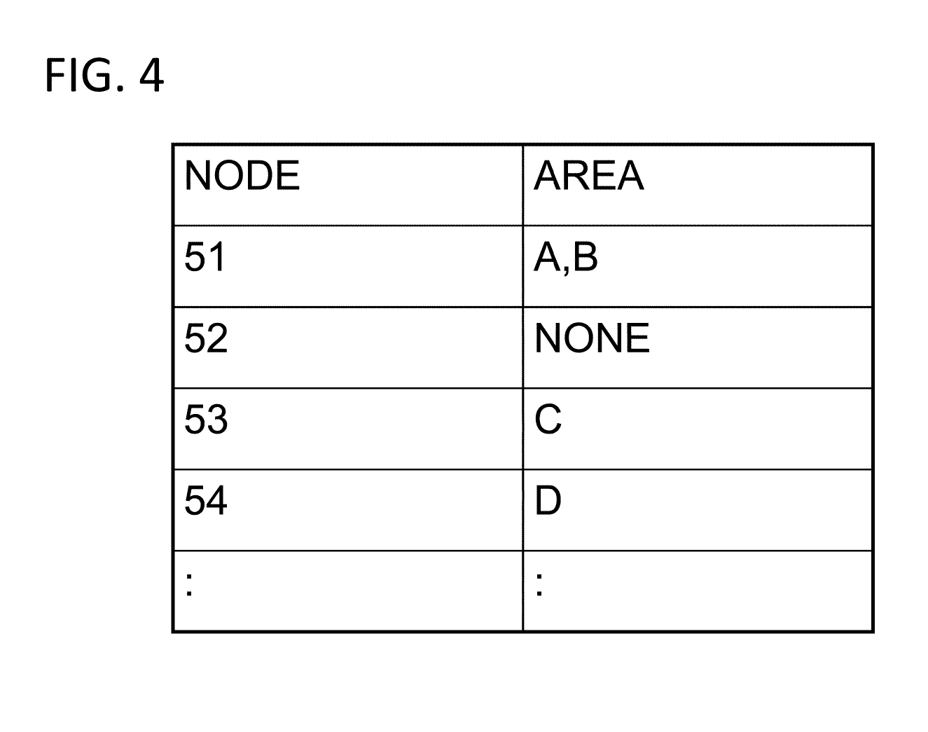

FIG. 4 shows an example of the node area information that indicates associations between the areas A to D shown in FIG. 6 and the nodes 51 to 54. In the example of FIG. 4, the single node 51 is associated with two areas A and B, as indicated by the numbers in parentheses in the corners of the areas in FIG. 6. Further, the nodes 53 and 54 are associated with the areas C and D. Moreover, no area is associated with the node 52. The reason why the threshold information (the number of data that can be stored) of the areas A and B is a half of the areas C and D in FIG. 3 is that the single node 51 is in charge of two areas.

The area specifying unit 3003 specifies the area where a client node belongs based on information notified by the client nodes 11 to 14. Examples of such information include GPS (Global Positioning System) information. Another example is the information of a base station that relays data in a case where the client node is a mobile telephone terminal. More concretely, a configuration having the area specifying unit 3003 hold a table for specifying area information based on these pieces of information notified by the client nodes 11 to 14 and specify the area where a client node belongs by referring to the table may be employed.

The node specifying unit 3004 selects a node to be the storage location of data transmitted by a client node in an area by referring to the node area information.

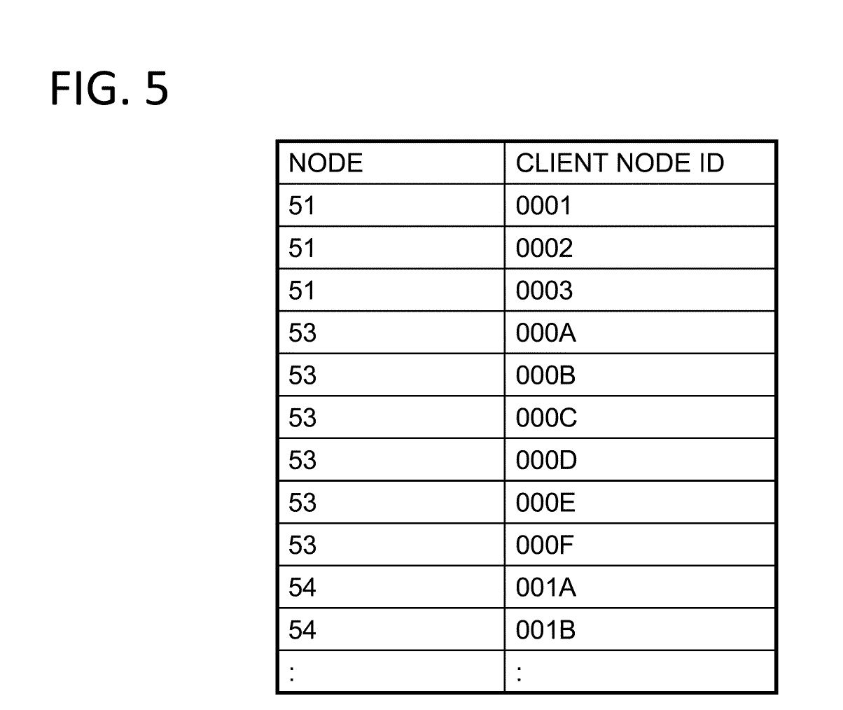

Based on information enabling unique identification of a client node, the client monitoring unit 3005 knows which client node each node manages. This management information is referred to as “client management information.” FIG. 5 is an example of a table for managing the client management information. Further, examples of such information that enables unique identification of a client node include client node ID in data notified to a data center. As another example, location information by GPS may be used.

The node area information management unit 3006 starts up when a node stores data from a new client node thereby exceeding its processing capacity, and updates the node area information by referring to the node area information and the client management information so that the number of areas handled by one node is at least one and the total number of client nodes present in geographically adjacent areas is within the number that one server can handle.

The CPU 3070 controls each unit of the distributed access node 30. The RAM 3071 and the HDD 3072 are used as the storage location of a program executed by the CPU 3070 and of the information used by each unit of the distributed access node. The input/output unit 3073 provides communication means.

Further, the example of FIG. 2 shows the CPU 3070 and each processing unit separately, however, each unit (processing means) of the distributed access node can be realized with a computer program that has the CPU 3070 execute each processing described above using the RAM 3071 and the HDD 3072.

Next, the operation of the present exemplary embodiment will be described in detail with reference to the drawings. Further, in the explanation below, it is assumed that the area configuration information shown in FIG. 3 is set in the node area information holding unit 3002 and so are the upper limit numbers of client nodes manageable by the nodes 51 to 54 (the number of data the nodes 51 to 54 can store) in the threshold information fields in preparation for the notification of transmitted data from each client node. Moreover, the explanation below will be made with an assumption that the number of client nodes manageable by each of the nodes 51 to 54 (the number of data the nodes 51 to 54 can store) is six.

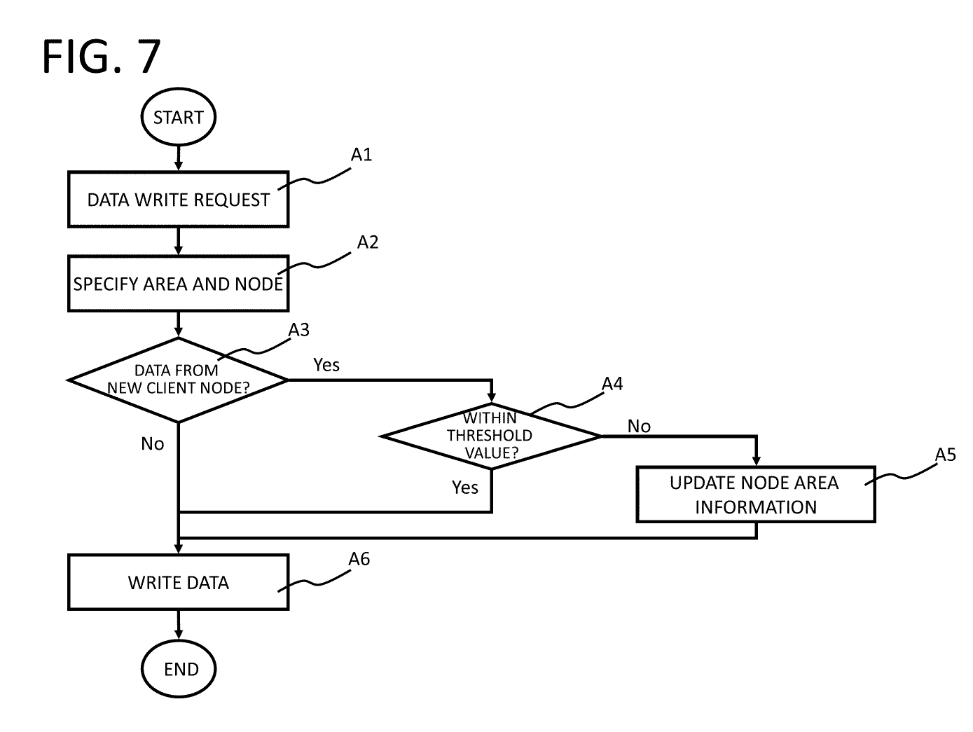

FIG. 7 is a flowchart showing the operation (distributed positioning algorithm) of the distributed access node of the first exemplary embodiment of the present invention. With reference to FIG. 7, first the distributed access node 30 receives a data write request from a client node (step A1). This data write request is performed by the transmission of data that includes location information from the client node to the distributed access node 30.

The distributed access node 30 specifies an area where the client node belongs based on the information included in or attached to the data transmitted from the client node. Further, the distributed access node 30 specifies a node associated with the specified area using the node area information (step A2).

Next, the distributed access node 30 confirms whether or not the specified node already holds data transmitted from this client node (step A3). This can be confirmed by checking whether or not the client management information (refer to FIG. 5) managed by the client monitoring unit 3005 has an entry having a combination of the client node ID of this client node and the specified node. When the specified node already holds data transmitted from this client node (No in the step A3), the data in the node is updated and overwritten (step A6).

On the other hand, when the specified node does not have data from this client node (Yes in the step A3), the distributed access node 30 determines whether or not adding the transmitted data from the client node to the specified node will cause the node to exceed the upper limit value of the number of client nodes manageable by the node (the number of data that can be stored in the node) by referring to the threshold information (step A4). When it is determined that the number of transmitted data will not exceed the upper limit value (Yes in the step A4), the operation proceeds to the step A6 and the data is newly added to the node (the step A6).

Meanwhile, when it is determined that the upper limit value of the number of client nodes manageable by the node (the number of data that can be stored in the node) will be exceeded in the step A4, the distributed access node 30 adds the client node that transmitted the data, reviews the relationship between the nodes and the areas, and updates the node area information (step A5). Here, in reviewing the relationship between the nodes and the areas, the number of areas handled by a single node should be as high as possible to the extent that the processing capability of the node is not exceeded. For instance, when the total number of client nodes present in geographically adjacent areas is not greater than the upper limit number handled by a single server, the node area information is updated so that these geographically adjacent areas are managed by a single node. After the update of the node area information, which node will manage the transmitted data from the client node is determined and the data is newly added to this node (the step A6). Further, the client monitoring unit 3005 adds an entry that associates the node with the client node to the client management information.

As described, nodes are assigned according to the area of a client node that has issued a new data request. For instance, in the situation in FIG. 6 in which the areas A and B are associated with the node 51 and the areas C and D are associated with the nodes 53 and 54, respectively, if a client node in the area A newly issues a data write request, the threshold value (the upper limit value of the number of client nodes=3) of the area A will be exceeded in the step A4 in FIG. 7. Therefore, in the node area information update processing in the step A5 in FIG. 7, the node area information is updated so that the node 52 is newly assigned to the area B (or A). Note that the node 52 is in an idle condition (no area is assigned thereto) in the node area information shown in FIG. 4.

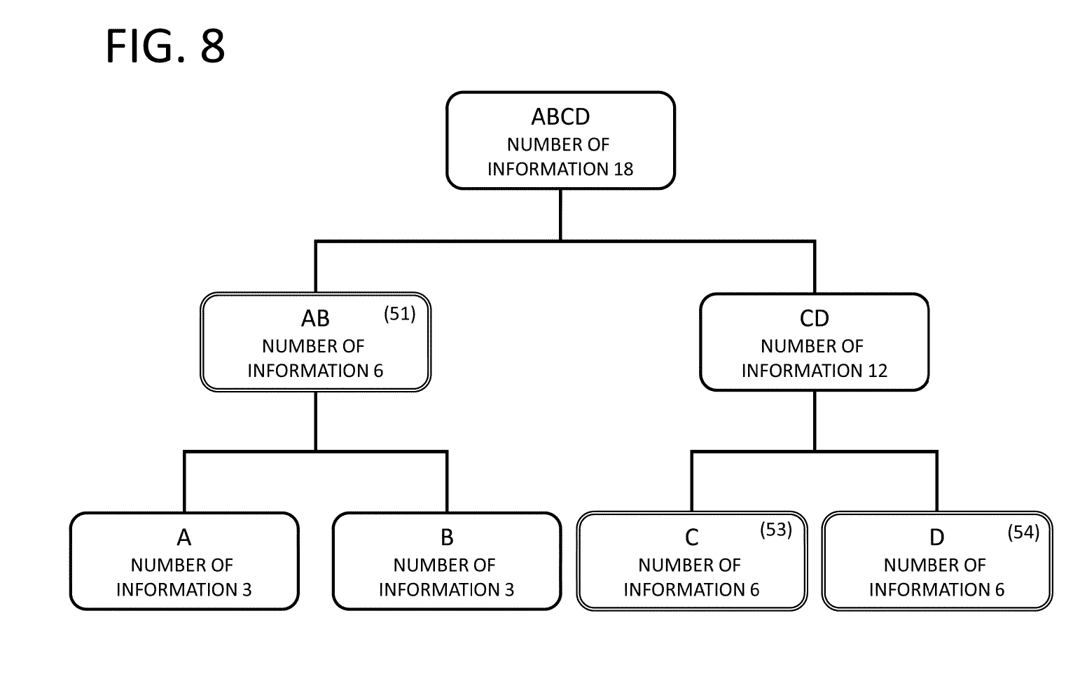

The node area information update processing can be performed using a client management information management tree shown in FIG. 8. FIG. 8 is a drawing showing the number of information (the number of client nodes) in each area in a tree structure. Further, numbers in parentheses indicate the node associated with an area. In the example of FIG. 8, there are three client nodes in each of the areas A and B, and a total of six client nodes are present in the areas A+B, one level up. Further, there are six client nodes in each of the areas C and D, and a total of twelve client nodes are present in the areas C+D, one level up. Meanwhile, since each of the nodes 51 to 54 can manage six client nodes, the node 51 is associated with the areas A+B, and the nodes 53 and 54 are associated with the areas C and D, respectively. In this condition, if a new client node located in the area A (or B) issues a data write request, the number of client nodes manageable by the node 51 associated with the areas A+B will be exceeded. Therefore, the area A (or B) will be assigned to the node 52.

The node 52 is associated with the area B as described, and FIG. 6 is rewritten to FIG. 9. Further, due to the addition of the node 52, each threshold value (the upper limit number of client nodes) of the areas A and B is rewritten to six.

As described, in the present exemplary embodiment, data placement can be autonomously performed while enabling a high-speed search on data transmitted by nearby client nodes and evenly distributing and placing data updated frequently in its entirety. The reason is that searches via the network are reduced by stopping searches within the nodes 51 to 54 and reducing searches spanning the nodes as much as possible, thereby eliminating the overhead of the network bandwidth and the network use. Further, the present exemplary embodiment has the benefit that it is possible to perform a high-speed search on data of neighboring client nodes since data from client nodes located closely with each other are placed in the same node as much as possible.

Further, since the client monitoring unit 3005 is provided in the present exemplary embodiment, the distributed access node 30 is able to perform load distribution without obtaining access information transmitted by the client nodes from the nodes 51 to 54.

Further, in the exemplary embodiment described above, the number of client nodes manageable by each of the nodes 51 to 54 is six, however, the number of client nodes manageable by each of the nodes 51 to 54 does not have to be the same and can be finely adjusted based on the memory region such as RAM and the processing capability such as the CPU speed of each of the nodes 51 to 54.

### Exemplary Embodiment 2

Next, described in detail with reference to the drawings is a second exemplary embodiment in which, out of entries of the client management information in the first exemplary embodiment of the present invention, ones meeting a predetermined deletion condition are deleted.

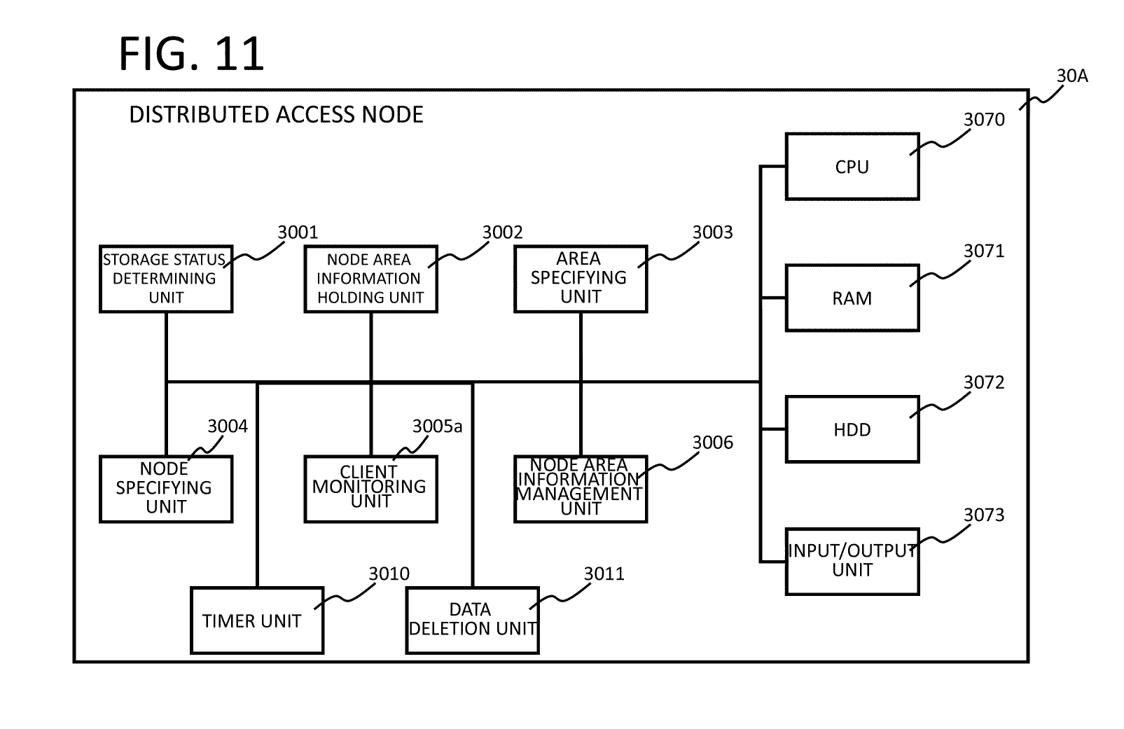

FIG. 11 is a block diagram illustrating the configuration of a distributed access node 30A of the second exemplary embodiment of the present invention. The distributed access node 30A differs from the distributed access node 30 of the first exemplary embodiment shown in FIG. 2 in that a timer unit 3010 and a data deletion unit 3011 are added. The second exemplary embodiment is substantially similar to the first exemplary embodiment; therefore the differences will be mainly described.

The timer unit 3010 is means for issuing a notification to the data deletion unit 3011 at a predetermined time interval.

Upon receiving a notification from the timer unit 3010, the data deletion unit 3011 deletes an entry that meets a predetermined deletion condition in the client management information held by the client monitoring unit.

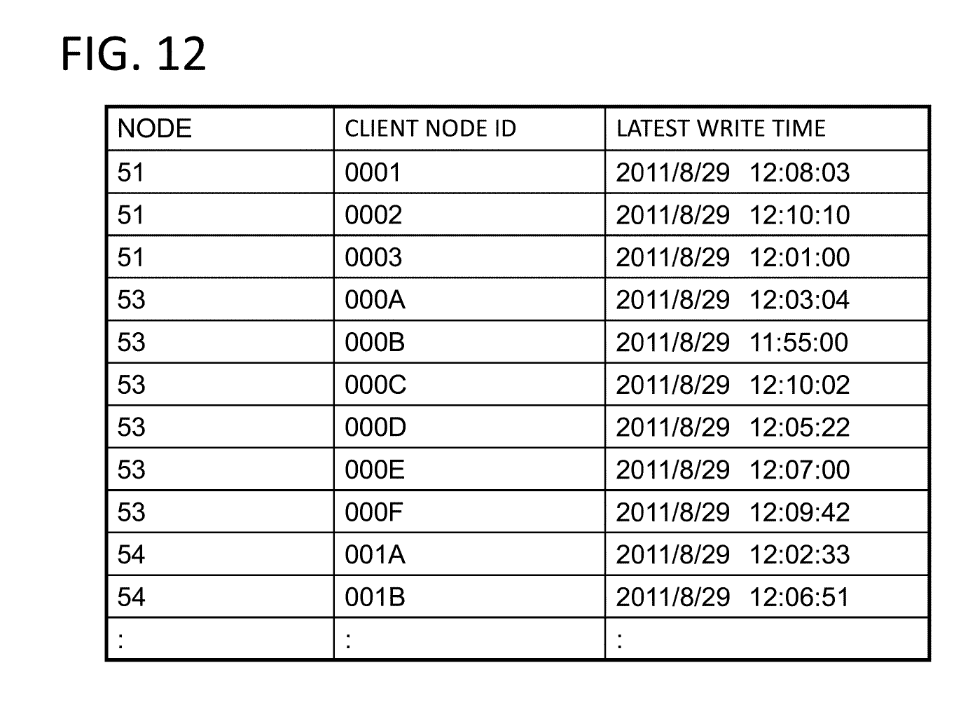

Further, as shown in FIG. 12, a client monitoring unit 3005a in the present exemplary embodiment updates the latest write time of the client management information every time it receives transmitted data from the client nodes 11 to 14 and writes the data to a node.

Next, the operation of the present exemplary embodiment will be described in detail with reference to the drawings. The basic operation of the distributed access node 30A is the same as the first exemplary embodiment of the present invention (refer to FIG. 7). In the present exemplary embodiment, the following operation is performed in parallel with the operation in FIG. 7 due to the addition of the timer unit 3010 and the data deletion unit 3011.

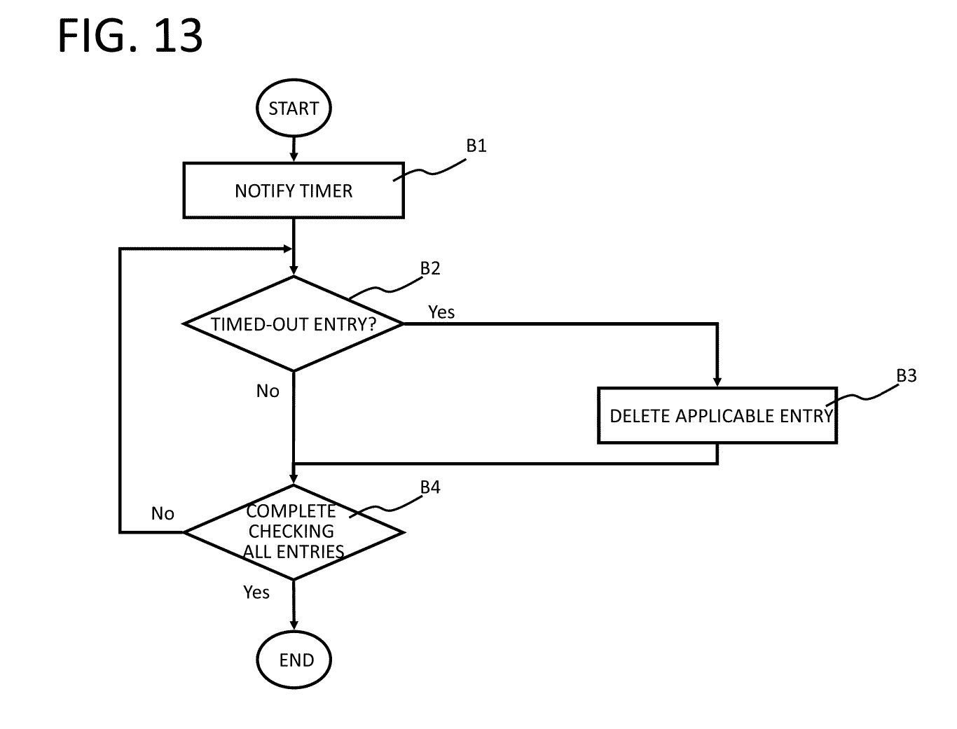

FIG. 13 is a flowchart showing the operation executed by the timer unit 3010 in the distributed access node 30A of the second exemplary embodiment of the present invention at a predetermined time interval.

With reference to FIG. 11, the timer unit 3010 issues a notification to the data deletion unit 3011 at a predetermined time interval (step B1).

Next, the data deletion unit 3011 reads an entry from the client management information held by the client monitoring unit 3005a, and confirms whether or not the difference between the current time and the latest write time exceeds a predetermined range (step B2). When the difference between the current time and the write time exceeds the predetermined range (determined to be timed out; Yes in the step B2), the data deletion unit 3011 deletes this entry (step B3). For instance, when the current time is 12:15 PM, the latest write time of the client node having ID 000B and stored in the node 53 is the oldest in FIG. 12; minutes have elapsed since the last write operation. If the threshold value is 15 minutes, this entry will be deleted.

The data deletion unit 3011 performs the judgment processing described on all entries in the client management information held by the client monitoring unit 3005a (No in step B4). When all entries in the client management information held by the client monitoring unit 3005a have been checked, a sequence of the processing ends (Yes in the step B4).

According to the present exemplary embodiment that performs the aging processing of the client management information described above, it becomes possible to delete an entry for an idle client node in the client management information held by the client monitoring unit 3005a, in addition to the effects of the first exemplary embodiment.

Further, in the present exemplary embodiment above, the distributed access node 30A performs the aging processing of the client management information, however, the same system may be added to the data detention mechanisms of the nodes 51 to 54. This makes it possible to have each of the nodes 51 to 54 autonomously delete data transmitted by an unnecessary client node.

Further, in the present exemplary embodiment above, an entry for which a predetermined time period has elapsed since the latest write time is deleted, however, other conditions may be added. For instance, the deletion judgment time may be different for each client node and area.

### Exemplary Embodiment 3

Next, described in detail with reference to the drawings is a third exemplary embodiment in which a function of controlling the operating state (power on/off, changing the operating mode, etc.) of each node is added to the distributed access node 30A of the second exemplary embodiment of the present invention.

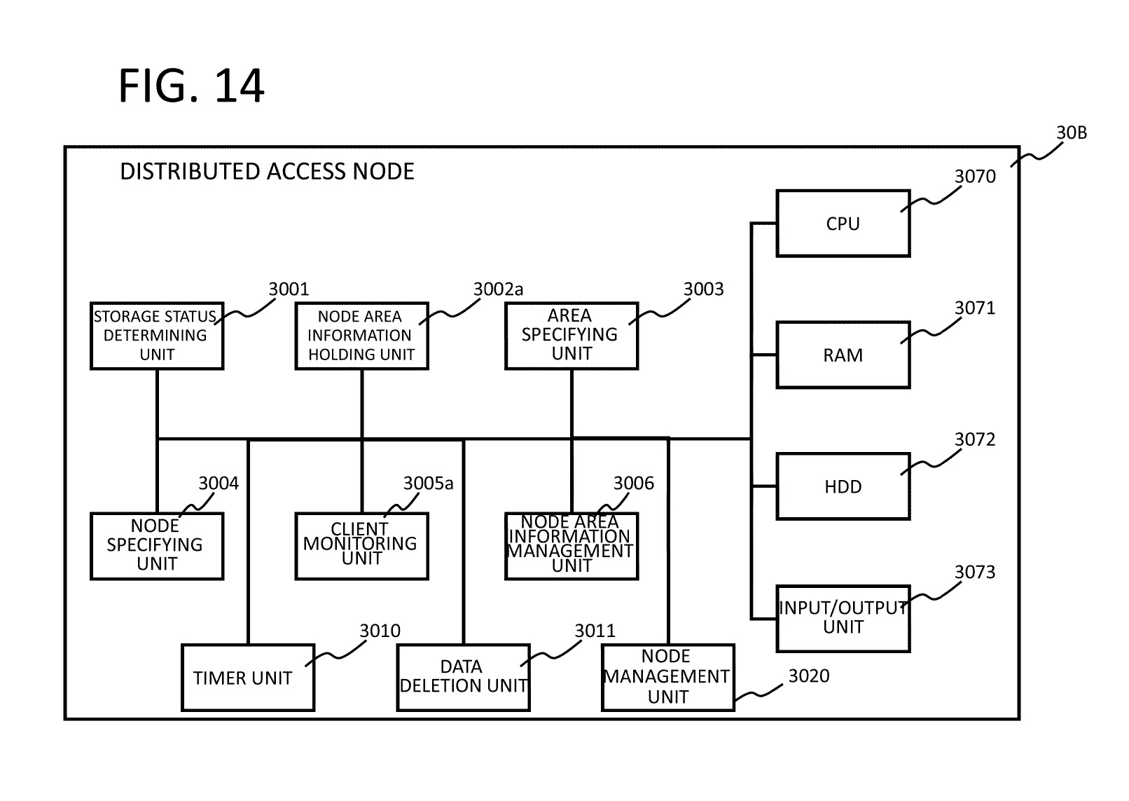

FIG. 14 is a block diagram illustrating the configuration of a distributed access node 30B of the third exemplary embodiment of the present invention. The distributed access node 30B differs from the distributed access node 30A of the second exemplary embodiment shown in FIG. 11 in that a node management unit 3020 is added. The third exemplary embodiment is substantially similar to the second exemplary embodiment; therefore the differences will be mainly described.

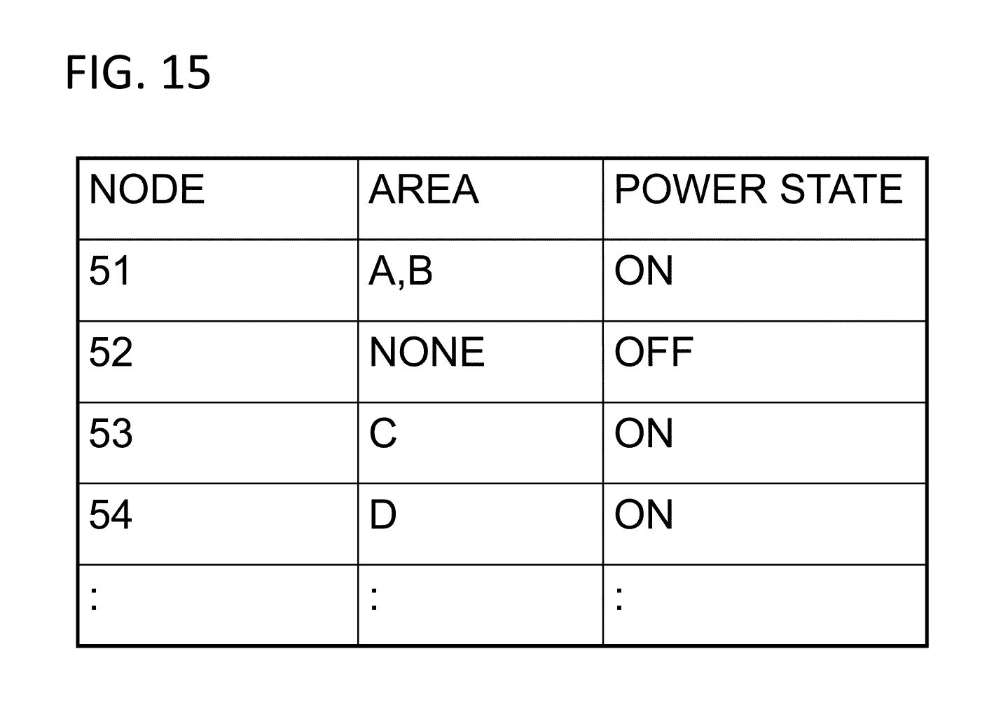

A node area information holding unit 3002a holds the node area information to which fields indicating the power state of each node are added, as shown in FIG. 15.

The node management unit 3020 determines whether or not the power of a node managing a reduced number of client nodes should be turned off or the operating mode thereof should be changed (to a power save mode, sleep mode, etc.), and issues a change command to an applicable node to turn the power off or change the operating mode (to a power save mode, sleep mode, etc.). Upon receiving a response from the node to which the power-off command is issued, the node management unit 3020 adds the fact that the node is turned off or in a sleep mode to the node area information shown in FIG. 15.

Next, the operation of the present exemplary embodiment will be described in detail with reference to the drawings. The basic operation of the distributed access node 30B is the same as the first and the second exemplary embodiments of the present invention (refer to FIGS. 7 and 13). In the present exemplary embodiment, the following operation is performed due to the addition of the node management unit 3020.

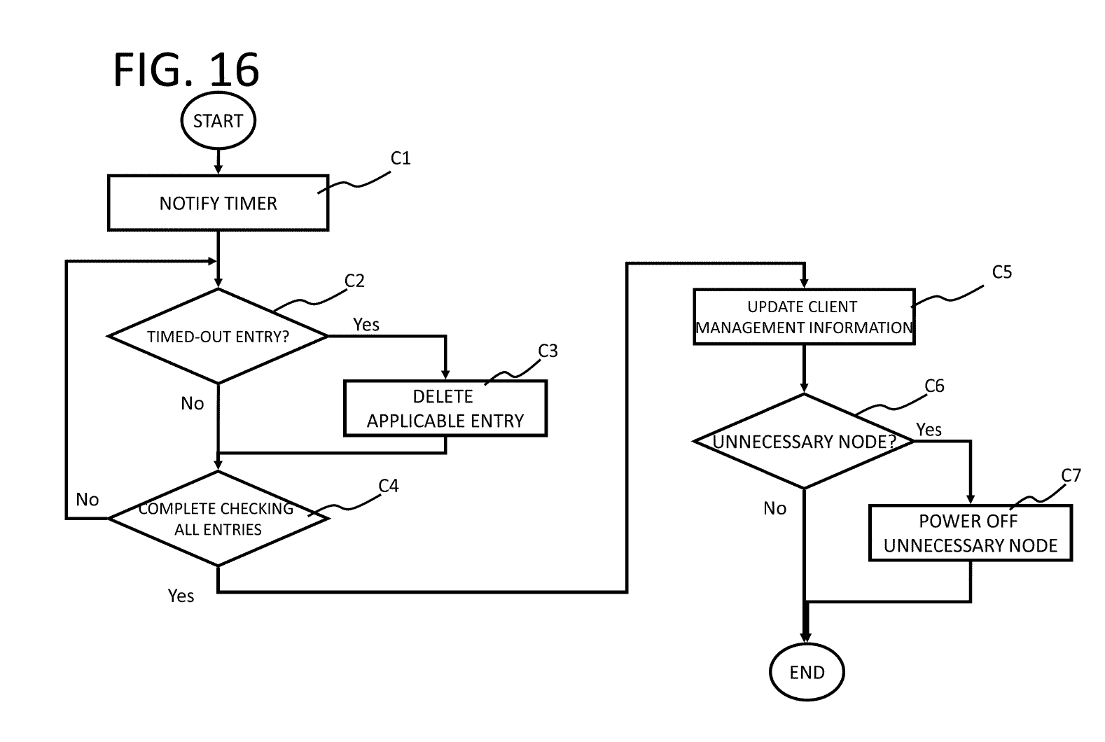

FIG. 16 is a flowchart showing the operation executed by the timer unit 3010 in the distributed access node 30B of the third exemplary embodiment of the present invention at a predetermined time interval.

Steps C1 to C4 in FIG. 16 correspond to the steps B1 to B4 in FIG. 13 describing the operation of the second exemplary embodiment. After all entries in the client management information have been checked, the node area information management unit 3006 updates the client management information (step C5). More concretely, based on the results of entry deletion in the step C3, the association between the nodes and the areas is reviewed so as to minimize the number of nodes covering the areas A to D.

The review can be performed in the following procedure. A single node should handle at least one area; therefore, if the number of areas a node handles is zero, it will be determined that this node is unnecessary. Further, when the total number of client nodes present in geographically adjacent areas is not greater than the number of client nodes manageable by a single node (here it is assumed to be six), these geographically adjacent areas are managed by a single node as a group. Adjacent areas can be lumped together until the number of client nodes located in these areas reaches the upper limit value of the number of client nodes manageable by a single node. For instance, if the total number of client nodes located in the areas A to D in FIG. 6 is six, one node will be able to cover the areas A to D and the other nodes will be unnecessary.

As a result of the update of the client management information in the step C5 in FIG. 16, whether or not there is any unnecessary node (having no client node associated therewith) is confirmed (step C6), and when there is, the power of this unnecessary node is turned off or the operating mode thereof is changed (to a power save mode, sleep mode, etc.) (step C7).

Further, regarding the node whose power has been turned off or operating mode has been changed (to a power save mode, sleep mode, etc.), the node management unit 3020 may turn the node on or change the operating mode again. For instance, in the step A5 of the first exemplary embodiment of the present invention, the node area information management unit 3006 may determine whether or not any node has an available capacity in terms of the number of data that can be stored. For instance, as shown in FIG. 6, when three nodes have reached the maximum number of data that can be stored, the node area information management unit 3006 may issue a power-on request to the node management unit 3020 to turn on the power of the node 52, for instance.

According to the present exemplary embodiment described above that reviews the node area information based on the operating status of the nodes, effects such as reducing the power consumption can be achieved in addition to the effects of the first and the second exemplary embodiment.

Preferred exemplary embodiments of the present invention have been described, however, the present invention is not limited to the exemplary embodiments above, and further modifications, substitutions, and adjustments may be done without departing from the basic technological concept of the present invention. For instance, in the exemplary embodiments above, the number of data that can be stored in each node (the number of manageable client nodes) is six, but the threshold information is not limited thereto. The threshold value may be changed according to the capability of each node or dynamically changed according to the time period.

Further, the exemplary embodiments above have been described assuming that the number of the client nodes and the number of transmitted data are the same, however, in a case where each node needs to hold old data transmitted by the client nodes, the number (the upper limit value) of transmitted data is greater than the number of the client nodes.

Further, in the exemplary embodiment described above, the upper limit value (the threshold information) is determined by the number of the client nodes and the number of transmitted data, however, the upper limit value may be determined by the data amount such as the number of bytes.

Further, in the exemplary embodiment described above, a node is added when the predetermined upper limit value (the threshold information) is exceeded, however, an lower limit value (the threshold information) may be defined, and when a node goes under the lower limit value, another node with available capacity among adjacent nodes may accommodate a client node managed by the node that goes under the lower limit value (the threshold information).

Further, in the exemplary embodiments described above, the comparison to the threshold information is triggered by the reception of data from a new client node, however, whether or not data transmitted from the client nodes is within the range of the threshold information may be confirmed at a predetermined time interval without making the comparison to the threshold information at the time of data reception from a new client node.

Further, the distributed access node may comprise the function of detecting that a client node has moved to an adjacent area, and update the client management information each time. In this configuration, data from this client node can be stored in a node after the move without waiting to receive data from the client node.

Further, the distributed access node may comprise the functions of detecting a change in the operating status of the client nodes and of deleting an entry of a client node in a non-operating state from the client management information. In this configuration, the number of entries in the client management information can be reduced and so can the number of nodes assigned to these nodes.

Further, in the exemplary embodiments described above, the location of each client node is specified based on data included in or attached to data transmitted by the client nodes, however, the location of a client node may be obtained from another subject. For instance, when the client nodes are mobile telephone terminals, location information can be received from the location management server thereof.

Finally, preferred modes of the present invention will be summarized.

### [Mode 1]

(Refer to the data placement system according to the first aspect.)

### [Mode 2]

In the data placement system of Mode 1,

the area specifying unit specifies an area where a client node is located based on information included in data transmitted from the client node or information attached to the data.

### [Mode 3]

In the data placement system of Mode 1 or 2,

the distributed access node further comprises:

a storage status determining unit that confirms at a predetermined interval of time whether or not data stored in each of the nodes and transmitted by the client node is within the range of threshold information determined for each node or each area; and

a node area information management unit that updates the node area information based on the confirmation results by the storage status determining unit so that data stored in each nodes and transmitted by the client node is within the range of the threshold information.

### [Mode 4]

In the data placement system of Mode 3,

a value corresponding to the processing capability of each node is set as the threshold information.

### [Mode 5]

In the data placement system of Mode 4,

the threshold information is calculated based on the memory region or the CPU speed of each node.

### [Mode 6]

In the data placement system of Mode 4 or 5,

the threshold information is calculated based on information included in a notification from each of the nodes at the time of network connection and system construction.

### [Mode 7]

In the data placement system of any one of Modes 3 to 6,

the distributed access node further comprises a client monitoring unit that holds client management information associating the specified node with the client node, and omits confirmation using the threshold value when a data source is a client node registered in the client management information.

### [Mode 8]

In the data placement system of Mode 7,

the distributed access node further comprises the functions of detecting that the client node has moved to an adjacent area and updating the client management information according to the detection results, and changes the storage location of data transmitted by the client node without waiting to receive data transmitted by the client node.

### [Mode 9]

In the data placement system of Mode 7 or 8,

the distributed access node further comprises the functions of detecting a change in the operating status of the client node and of deleting an entry of a client node in a non-operating state from the client management information according to the detection results.

### [Mode 10]

In the data placement system of any one of Modes 7 to 9,

the distributed access node further comprises a data deletion unit that deletes an entry meeting a predetermined deletion condition out of entries in the client management information at a predetermined time interval.

### [Mode 11]

In the data placement system of any one of Modes 3 to 10,

the node area information management unit associates a node with a plurality of areas within the range of the threshold information.

### [Mode 12]

In the data placement system of any one of Modes 1 to 10,

the distributed access node further comprises a node management unit that changes the state of a node that does not store data transmitted by the client node to a power-off or hibernation state.

### [Mode 13]

In the data placement system of Mode 12,

the node area information management unit determines whether or not each of the node has available capacity to store data when the node area information is updated, and requests the node management unit to add a node when the capacity if insufficient, and

the node management unit changes the state of a node that does not store data transmitted by the client node to a power-on state or operating state in response to the request.

### [Mode 14]

(Refer to the distributed access node according to the second aspect.)

### [Mode 15]

(Refer to the data placement method according to the third aspect.)

### [Mode 16]

(Refer to the program according to the fourth aspect.)

Further, Modes 14 to 16 can be developed into derivative modes as Modes 2 to 13.

Further, the disclosure of Patent Literature listed above is incorporated herein by reference thereto.

It should be noted that other objects, features and aspects of the present invention will become apparent in the entire disclosure and that modifications may be done without departing the gist and scope of the present invention as disclosed herein and claimed as appended herewith. Also it should be noted that any combination of the disclosed and/or claimed elements, matters and/or items may fall under the modifications aforementioned. Particularly, the ranges of the numerical values used in the present document should be interpreted as a specific numeric value or small range included in the ranges even in cases where it is not stated so.

### REFERENCE SIGNS LIST

11, 12, 13, 14: client node
20: network
30, 30A, 30B: distributed access node
40: distributed system network
51, 52, 53, 54: node
3001: storage status determining unit
3002, 3002a: node area information holding unit
3003: area specifying unit
3004: node specifying unit
3005, 3005a: client monitoring unit
3006: node area information management unit
3010: timer unit
3011: data deletion unit
3020: node management unit
3070: CPU
3071: RAM
3072: HDD
3073: input/output unit

1. A data placement system, comprising:
a plurality of nodes that store data transmitted by a client node at a predetermined frequency; and
a distributed access node arranged between said plurality of nodes and said client node;
said distributed access node comprising:
a node area information holding unit that holds node area information associating each of said nodes with at least one piece of area information;
an area specifying unit that specifies an area where said client node is located; and
a node specifying unit that selects a node associated with said specified area as a storage location of data transmitted by said client node.

2. The data placement system according to claim 1, wherein said distributed access node further comprises:
a storage status determining unit that confirms at a predetermined interval of time whether or not data stored in each of said nodes and transmitted by said client node is within a range of a threshold value indicated by threshold information determined for each node or each area; and
a node area information management unit that updates said node area information based on the confirmation results by said storage status determining unit so that data stored in each nodes and transmitted by said client node is within the range of said threshold value.

3. The data placement system according to claim 2, wherein said distributed access node further comprises a client monitoring unit that holds client management information associating said specified node with said client node, and omits confirmation using said threshold value when a data source is a client node registered in said client management information.

4. The data placement system according to claim 3, wherein said distributed access node further comprises a data deletion unit that deletes an entry meeting a predetermined deletion condition out of entries in said client management information at a predetermined time interval.

5. The data placement system according to claim 3, wherein said node area information management unit associates a node with a plurality of areas within the range of said threshold value.

6. The data placement system according to claim 1, wherein said distributed access node further comprises a node management unit that changes the state of a node that does not store data transmitted by said client node to a power-off or hibernation state.

7. A distributed access node arranged between a plurality of nodes that store data transmitted by a client node and said client node, said distributed access node comprising:
a node area information holding unit that holds node area information associating each of said nodes with at least one piece of area information;
an area specifying unit that specifies an area where said client node is located; and
a node specifying unit that selects a node associated with said specified area as a storage location of data transmitted by said client node.

8. The distributed access node according to claim 7 wherein threshold information with which each node or each area can store data transmitted by said client node is included in each entry of said node area information;
the distributed access node further comprising:
a storage status determining unit that confirms at a predetermined interval of time whether or not data stored in each of said nodes and transmitted by said client node is within a range of a threshold value indicated by threshold information that specifies how much data transmitted by said client node each node or each area can store; and
a node area information management unit that updates said node area information based on the confirmation results by said storage status determining unit so that data stored in each nodes and transmitted by said client node is within the range of said threshold value

9. A data placement method for selecting a storage location of data transmitted by a client node from a plurality of nodes, said data placement method comprising:
having a distributed access node arranged between said plurality of nodes and said client node specify an area where said client node is located; and
having said distributed access node select a node associated with said specified area as a storage location of data transmitted by said client node by referring to node area information associating each of said nodes with at least one piece of area information.

10. The data placement method according to claim 9, wherein said node area information holding unit includes threshold information with which each node can store data transmitted by said client node;
the method further comprising:
having said distributed access node confirm at a predetermined interval of time whether or not data stored in each of said nodes and transmitted by said client node is within a range of a threshold value indicated by threshold information that specifies how much data transmitted by said client node each node can store; and
having said distributed access node update said node area information based on the confirmation results so that data stored in each nodes and transmitted by said client node is within the range of said threshold value.

11. The data placement system according to claim 4, wherein said node area information management unit associates a node with a plurality of areas within the range of said threshold value.

12. The data placement system according to claim 2, wherein said distributed access node further comprises a node management unit that changes the state of a node that does not store data transmitted by said client node to a power-off or hibernation state.

13. The data placement system according to claim 3, wherein said distributed access node further comprises a node management unit that changes the state of a node that does not store data transmitted by said client node to a power-off or hibernation state.

14. The data placement system according to claim 4, wherein said distributed access node further comprises a node management unit that changes the state of a node that does not store data transmitted by said client node to a power-off or hibernation state.

15. The data placement system according to claim 5, wherein said distributed access node further comprises a node management unit that changes the state of a node that does not store data transmitted by said client node to a power-off or hibernation state.
